(19) United States
(12) Patent Application Publication
(10) Pub. No.: US 2023/0112874 A1
(43) Pub. Date: Apr. 13, 2023

(54) HYDROPNEUMATIC SUSPENSION COMPONENT

(71) Applicant: CARBON AIR LIMITED, Greater Manchester (GB)

(72) Inventors: John FitzGerald COAKLEY, Derbyshire (GB); James MASSAGLIA, Lancashire (GB)

(21) Appl. No.: 17/801,947

(22) PCT Filed: Feb. 26, 2021
(86) PCT No.: PCT/GB2021/050507

§ 371 Date: Aug. 24, 2022

(30) Foreign Application Priority Data
Feb. 26, 2020 (GB) 2002732.2

(51) Int. Cl. F16F 9/06; F16F 9/42; B60G 13/06; F16F 9/32

(52) U.S. Cl. CPC F16F 9/065; F16F 9/067; F16F 9/42; B60G 13/06; F16F 9/3214; F16F 2224/0225; F16F 2222/12; F16F 2230/42; F16F 2230/02; B60G 2202/23; B60G 2206/41; B60G 2800/162

(57) ABSTRACT

The invention relates to a hydropneumatic suspension component such as a gas charged damper. The invention further relates to a floating piston for a hydropneumatic suspension component. Uses of adsorbent material and/or open-cell foam are also disclosed.

### FIELD OF THE INVENTION

The present invention relates to improvements in hydropneumatic suspension components such as gas charged dampers (also known as shock absorbers), for a vehicle chassis.

### BACKGROUND

Numerous hydropneumatic suspension components such as dampers (shock absorbers) and methods for the production of such devices are known in the field of vehicle engineering, in particular chassis engineering.

Some hydropneumatic components feature centralised or distributed spheres at each corner of the vehicle containing pressurised gas which acts on a hydraulic fluid within via a flexible membrane or floating piston which isolates the gas from the fluid using dynamic seals. The hydraulic fluid acts on pistons within the suspension of the vehicle, bearing the load of the chassis, with the pressurised gas cavity providing compressibility remotely. The hydraulic fluid may be fed through restrictive passages or orifices to also provide damping effects on the suspension fluid directly.

More commonly, dampers are part of the chassis of motor vehicles and they generally interact there with springs (often misnamed as “shock absorbers”) which absorb the shock whenever a wheel encounters a bump in the road. While these springs ensure that the wheels after a deflection are always returned to their starting position, they have the tendency to extend a little further than necessary and this causes the vehicle to bounce a few times before settling down. The dampers (shock absorbers) dampen this motion, and ensure that the wheel/vehicle oscillations subside as rapidly as possible.

In either case, the damper works by forcing a piston containing complex orifices, perforations, valves, plates and the like, through a chamber containing a damping fluid (typically oil) inside a cylinder. The frictional resistance incurred within the fluid causes kinetic energy to be converted into heat, thereby dissipating that energy and inhibiting vehicle resonance and bouncing action. The tortuous paths created within the piston control the damping characteristics, in terms of response to speed, direction and sometimes the position of the piston within the stroke.

There are two issues relating to the damping fluid that must be managed.

Firstly, cavitation must be avoided. This occurs when a zone of low pressure appears in the damping fluid as the piston is passed through it, causing gas dissolved in the fluid to reappear as small bubbles. These bubbles spoil the damping behaviour of the fluid as it passes through the piston and/or other damping elements in the system. The traditional solution is to keep the fluid pressurised.

Secondly, since oil and other damping fluids are essentially incompressible, extra space must be provided for it to occupy when the piston rod enters the damping chamber, thereby displacing volume that the fluid would otherwise occupy.

The solution to these two issues is to use a variable volume chamber that comprises a first portion volume for holding a pressurised gas and a separate second portion volume, for holding a non-gaseous fluid (damping fluid) used as a damping medium. The first portion volume holding the pressurised gas may be isolated and/or sealed from the second portion volume holding the non-gaseous fluid by a secondary floating piston. As the secondary floating piston is backed by the pressurised gas in the first portion volume, this keeps the non-gaseous under pressure of the stroke of the main piston. In an alternative arrangement, the same effect may be achieved by replacing the floating piston with a flexible impermeable polymeric bladder to form a first portion volume for holding a pressurised gas (i.e. air or nitrogen) that is positioned at one end of the second portion volume that will compress to make way for damping fluid toward the end of a compression stroke.

This is known as a monotube damper. Its performance is limited in one critical way; a significant proportion of the second portion volume for holding the non-gaseous fluid must be given over to the first portion volume for holding the pressurised gas, thereby limiting stroke. This is because pressure inside a smaller volume will rise dramatically as the piston approaches the end of stroke, restricting the piston's movement and causing the damper as a whole to stiffen.

This stiffening effect is independent of the spring rate of the primary springs that bear the load of the vehicle and is undesirable because it stops a damper from behaving in a consistent, linear fashion, inhibiting suspension progress toward the end of travel and raising hysteresis in the damping curve since the damping forces in extension will become significantly lower than the damping forces in compression.

There are several solutions to this problem, mostly variations on two key types.

The first is the twin tube damper, which allows the piston to travel all the way to the end of the second portion volume for holding the non-gaseous fluid by essentially creating a secondary cavity in the cylinder wall, allowing the damping fluid to pass into the cavity which itself is charged with pressurised gas. The disadvantage to this is that it is heavier, bulkier, more complex than a monotube, and the cavity wall acts to thermally insulate the working damping fluid-containing chamber. This can result in excessive heat build-up in the damping fluid altering its viscosity and leading to changed damping behaviour.

The second solution type involves the addition of an auxiliary or “piggyback” chamber bolted to the side of a main chamber and connected via a hose. The auxiliary or “piggyback” chamber contains the floating piston, which therefore isolates the damping fluid from the pressurised gas volume, thereby providing a pressurised overflow to the main chamber that, like the twin tube, can be governed by a secondary valve arrangement to give further tuneability. However, this piggyback arrangement also incurs extra packaging volume, complexity, cost and weight.

The invention therefore aims to mitigate or eliminate one or more of the aforesaid disadvantages of the known art.

### SUMMARY OF THE INVENTION

According to a first aspect, the present invention provides a hydropneumatic suspension component comprising: a variable-volume chamber having a first portion volume for holding a pressurised gas and a separate second portion volume for holding a non-gaseous fluid used as a damping medium, wherein the first portion volume is isolated from the second portion volume, and further wherein the first portion volume comprises a mass of adsorptive material and/or open-cell foam to limit the build-up of pressure as the first portion volume is compressed in use by the non-gaseous fluid provided in the second portion volume.

In one embodiment, the present invention provides a hydropneumatic suspension component comprising: a variable-volume chamber having a first portion volume for holding a pressurised gas and a separate second portion volume for holding a non-gaseous fluid used as a damping medium, wherein the first portion volume is isolated from the second portion volume, and further wherein the first portion volume comprises a mass of adsorptive material and/or open-cell foam.

An effect from the use of a mass of adsorptive material and/or open-cell foam is that the spring rate of the pressurised gas in the first portion volume is reduced. A further effect is a reduction in hysteresis.

The term “hydropneumatic suspension component” as used herein, is intended to mean suspension components that utilize both a non-gaseous fluid and a gaseous fluid. An example of such a component is a damper (also known as a shock adsorber).

The term “pressurised gas” as used herein means gas held at a pressure above atmospheric pressure.

A particular advantage in some embodiments of the present invention is that the non-gaseous fluid in the second portion volume is isolated from the first portion volume. This is particularly beneficial in embodiments that contain a mass of adsorptive material because if a non-gaseous fluid was to mix and/or contact the adsorptive material, this could mask the pores of the adsorptive material and stop it from adsorbing gas.

The term “isolated” as used herein therefore means the non-gaseous fluid in the second portion volume is prevented from mixing and/or contacting the first portion volume.

In one embodiment, the present invention provides a hydropneumatic suspension component comprising: a variable-volume chamber having a first portion volume for holding a pressurised gas and a separate second portion volume for holding a non-gaseous fluid used as a damping medium, wherein the first portion volume is isolated from the second portion volume, and further wherein the first portion volume comprises a mass of adsorptive material.

Advantageously, the use of a mass of adsorptive material limits the build-up of pressure as the first portion volume is compressed in use by the non-gaseous fluid provided in the second portion volume.

Additionally, or alternatively, the present invention provides a hydropneumatic suspension component comprising: a variable-volume chamber having a first portion volume for holding a pressurised gas and a separate second portion volume for holding a non-gaseous fluid used as a damping medium, wherein the first portion volume is isolated from the second portion volume, and further wherein the first portion volume comprises a mass of open-cell foam.

Advantageously, the use of a mass of open-cell foam limits the build-up of pressure as the first portion volume is compressed in use by the non-gaseous fluid provided in the second portion volume.

Additionally, or alternatively, the present invention provides a hydropneumatic suspension component comprising: a variable-volume chamber having a first portion volume for holding a pressurised gas and a separate second portion volume for holding a non-gaseous fluid used as a damping medium, wherein the first portion volume comprises a mass of open-cell foam.

In this embodiment, this means that the non-gaseous fluid in the second portion volume can mix and/or contact the first portion volume.

Alternatively, in this embodiment, the first portion volume is isolated from the second portion volume. This means that the non-gaseous fluid in the second portion volume is prevented from mixing and/or contacting the first portion volume.

In one embodiment, the open cell foam is treated with an oleophobic coating, and/or may comprise intrinsic oleophobic qualities.

In one embodiment, and most preferably, the open-cell foam as described herein is a heat sink material.

An example of such a heat sink material is Basotect G by BASF. This is an open cell foam made from melamine, a thermoset polymer. Its characteristic feature is very high porosity (99.4%) with a highly cross-linked three-dimensional skeletal frame consisting of slender webs. This results in a small average pore size (in excess of 75 pores per inch (ppi)) and high surface area which combine to enable the rapid conduction of heat from the air to the skeleton matrix.

In one embodiment, the open cell foam is thermoset polymer, preferably made from melamine resin.

In one embodiment, the open cell foam has a porosity of from about 70% to less than 100%, preferably from about 90% to less than 100%, further preferably from about 95% to less than 100%, and most preferably from about 99% to less than 100%.

In one embodiment, the open cell foam has an average pore size of greater than 60 pores per inch (ppi), preferably greater than 80 ppi, and most preferably greater than 130 ppi.

In one embodiment, the open cell foam is a thermoset foam made from melamine resin, and comprises a porosity of from about 99% to less than 100%, and further comprises an average pore of greater than 120 pores per inch.

It is appreciated that the same type of open cell foam may be used to both reduce spring rate as well as provide isolation, as described herein. Alternatively, one type of open cell foam may be used to reduce spring rate, and another type of open-cell foam may be used to provide isolation.

The use of an open-cell foam to limit the build-up of pressure is particularly advantageous in environments where temperatures may rise to 120° C. and/or where peak pressures must not be allowed to get too high. In particular, the open-cell foam as a heat sink material allows heat to be removed from the device in use.

Furthermore, the use of an open-cell foam is also desirable where the adsorbent material cannot be prevented from mixing and/or contacting the non-gaseous fluid. Therefore, the use of an open-cell foam may be used as a replacement for an adsorbent material in a hydropneumatic suspension component.

In one embodiment, the present invention provides the use of a mass of open-cell foam as a replacement for an adsorbent material in a hydropneumatic suspension. Such use limits the build-up of pressure. Most preferably, the open-cell foam is a heat sink material.

In one embodiment, the first portion volume comprises a pressurised gas and the second portion volume comprises a non-gaseous fluid. The first portion volume may further comprise a mass of adsorptive material and/or a mass of open-cell foam as described herein.

In one embodiment, the first portion volume is isolated from the second portion volume, by an element selected from the group consisting of a moveable member, a flexible divider, oleophobic filter, an open-cell foam, and any other dividing means to enable the exertion of pressure on the non-gaseous fluid in the second portion volume by the pressurised gas in the first portion volume.

In one embodiment, the first portion volume is isolated from the second portion volume, by an element selected from the group consisting of a moveable member, a flexible divider and an open-cell foam.

An example of a moveable member is a floating piston. An example of a flexible divider is a flexible impervious membrane.

In one embodiment, the first portion volume is fluidly sealed from the second portion volume.

In one embodiment, the first portion volume is fluidly sealed from the second portion volume, by an element selected from the group consisting of a moveable member and a flexible divider.

The term “fluidly sealed” used herein means that the pressurised gas and the adsorbent material and/or the open-cell foam in the first portion volume are/is preventing from mixing and/or contacting the non-gaseous fluid in the second portion volume.

In one embodiment, the adsorptive material is activated carbon. Preferably, the adsorptive material is in loose granular form. Preferably, the adsorptive material is provided in combination with an open cell foam filter or a fine gauze. The open cell foam filter and/or fine gauze may be treated with an oleophobic coating, or may comprise intrinsic oleophobic qualities.

In one embodiment, the adsorptive material is in the form of a self-supporting element or monolith, with the granules having been preferably bound together using a binder.

In one embodiment, the first portion volume is isolated from the second portion volume, or alternatively the first portion volume is fluidly sealed from the second portion volume, by an element selected from a moveable member (such as a floating piston); a flexible divider, such as a flexible impervious membrane; and any other dividing means to enable the exertion of pressure on the non-gaseous fluid in the second portion volume by the gas in the first portion volume.

In one embodiment, the first portion volume is provided in a cavity between an inner tube and an outer tube and the adsorptive material is isolated from the non-gaseous fluid preferably by an oleophobic filter or an open-cell foam.

In one embodiment, the first portion volume is provided in a cavity between an inner tube and an outer tube and the first portion volume comprises an open-cell foam. The mass of open-cell foam may substantially fill the first portion volume of the device.

As used herein the term “cavity” means a hollowed-out space between two walls. As an example, if a tube of small diameter was position inside a tube of large of diameter, one wall could be the inside wall of the tube of large diameter, and the other wall could be the outside wall of the tube of small diameter. The cavity would therefore be the space between such walls.

In one embodiment, the first portion volume is provided in one or more conduits positioned on an outer surface of a tubular housing. In one embodiment, the first portion volume is provided in two or more conduits positioned on an outer surface of a tubular housing.

Such a conduit is preferably parallel with an axis of the piston rod that may be provided in a tubular housing. A tube is an example of a tubular housing having a circular cross-section.

As used herein the term “conduit” means a passageway for a material or a fluid (non-gaseous and/or gaseous). This means that the conduit could therefore be any of any shape to allow such passage, but that it is generally of narrow width or diameter.

Preferably, the outer surface comprises cooling fins on or adjacent the one or more conduits, and preferably which span the length of the conduit. The conduit may contain a mass of adsorptive material and/or open-cell foam. The conduit may extend only partially along the length of the tubular housing, revealing the tubular housing to the outside air along the remainder of its length.

The one or more conduits may surround from 10 to 90% preferably from 10 to 75%, further preferably from 20 to 60%, of a circumference of the tubular housing. The tubular housing may also be provided with one or more cooling fins on the circumference that is not surrounded by the one or more conduits.

In one embodiment, an auxiliary or “piggyback” chamber is further provided in fluid communication with the non-gaseous fluid in the second volume chamber via a rigid or non-rigid connection, and housing the first portion volume. This first portion volume may comprise a mass of adsorptive material and/or open-cell foam.

In one embodiment, the adsorptive material and/or open cell foam is attached to or contained within a moveable member. Preferably, the adsorptive material is in fluid communication with the first portion volume, via a porous membrane or open-cell foam.

In one embodiment, the adsorptive material is a bound unitary element of adsorptive material exposed to the first portion volume.

In another embodiment, the adsorptive material and/or open cell foam is exposed to the first portion volume through one or more orifices.

In one embodiment, the adsorptive material is an activated carbon featuring high levels of mesoporosity and low levels of microporosity such as activated carbon derived from wood, in order to make it less susceptible to spoiling through exposure to VOCs such as fumes and fine mists of oil and damping fluids, and to make it less susceptibility to high pressure swings in response to changes in temperature.

The hydropneumatic suspension component according to the present invention is preferably a gas charged damper. In one embodiment, a vehicle comprises a hydropneumatic suspension component according to the present invention.

In a further aspect, the present invention provides a use of a mass of adsorptive material and/or open cell foam in a hydropneumatic suspension component. Advantageously, the use of mass of adsorptive material and/or open cell foam limits the build-up of pressure in a volume for holding a pressurised gas. Similarly, the effect is that the spring rate of the pressurised gas in the first portion volume is reduced.

In a further aspect, the present invention provides, a use of a mass of adsorptive material and/or open cell foam in a hydropneumatic suspension component comprising a damping component to limit the amount of damping hysteresis.

In a further aspect, the present invention provides a use of a mass of adsorptive material and/or open cell foam in the pressurised cavity and/or volume of a gas charged damper to limit the amount of damping hysteresis.

In a further aspect, the present invention provides a hydropneumatic suspension component comprising: a variable-volume chamber having a first portion volume for holding a pressurised gas and separate second portion volume for holding a non-gaseous fluid used as a damping medium, wherein the first portion volume is provided in one or more conduits that partially surround an outer surface of a housing comprising the second portion volume.

In one embodiment, the housing comprising the second portion volume is tubular. A tube is an example of a housing.

In one embodiment, the one or more conduits surround from 10 to 90% of a circumference of the tubular housing.

In one embodiment, the tubular housing is provided with one or more cooling fins on the circumference that is not surrounded by the one or more conduits.

In one embodiment, the first portion volume comprises an adsorbent material and/or an open-cell foam. An example of an adsorbent material is activated carbon. Preferably, the open-cell foam is a heat-sink material. The mass of open-cell foam may substantially fill the first portion volume of the device.

In one embodiment, the non-gaseous fluid in the second portion volume is isolated from the adsorbent material in the first portion volume. Preferably, the second portion volume is isolated from the first portion volume by an oleophobic filter and/or an open-cell foam.

In a further aspect, the present invention provides a floating piston for a hydropneumatic suspension component comprising: a main body comprising a chamber having an opening, and in which the chamber contains a mass of adsorptive material and/or open cell foam. This limits the build-up of pressure in a hydropneumatic suspension component.

In one embodiment, the main body is formed from a plastics material and/or a metal material.

In one embodiment, the opening comprises a grill or a mesh, and which is preferably provided in combination with an oleophobic filter, foam, or membrane.

In one embodiment, the main body is further provided with sealing and/or scraping means that are arranged to communicate with a bore of the hydropneumatic suspension component in use.

In one embodiment, the floating piston further comprises a pressurised gas.

In one embodiment, a hydropneumatic suspension component comprises a floating piston according to the present invention.

In a further aspect, the present invention provides a container for carrying an adsorptive material and/or open cell foam within a pneumatic apparatus such as a gas charged damper or air spring. The adsorptive material may be in granular form and held under pressure by a compressible open-cell foam which itself is contained behind a grill or restricted opening. Alternatively, the adsorptive material is in monolith form.

In one embodiment, the container further comprises walls that feature anti-drip details such as grooves or overhanging lips, preferably to limit the migration of oil, damping fluid condensation or other liquid contaminant from meeting the containing filter.

According to a further aspect, the present invention provides, a quantity of adsorptive material and/or open cell foam disposed within the pressurised gas volume of a gas-charged chamber within a hydropneumatic suspension component. The gas charged chamber may be formed behind a separator piston, or isolation may be achieved by a flexible membrane divider.

In one embodiment, a hybrid monotube/twin tube damper is described, which uses a quantity of adsorptive material disposed in the outer chamber of a twin tube configuration to negate the need of the outer chamber to fully envelop the inner chamber. The upper portion of the device consists of the inner chamber exposed directly to the outside air, optionally with the aid of fin extrusions acting as external heat sinks along the length of the upper chamber.

As described above, the open-cell foam as discussed herein is preferably a heat sink material.

### DESCRIPTION OF THE INVENTION

The build up of pressure in a chamber comprising gas under compression can be reduced using materials that support a process called adsorption. Gas molecules become entrained by Van der Waals forces within the micropores of the adsorptive material. When this happens, the gas molecules stop contributing to pressure within the chamber. The consequence of this is that a smaller chamber comprising materials that support adsorption can be used to achieve the same pressure with respect a larger volume that does not comprise such materials.

In the case of a hydropneumatic suspension component that is a monotube damper, the length of damping stroke available can be increased without incurring prohibitive build-up in pressure at maximum compression, or the increase in hysteresis that occurs as a consequence of this.

According to an aspect of the invention, part of a pressurised cavity in a twin tube shock is filled with an adsorptive material and/or open-cell foam. The adsorptive material is isolated from the pressurised gas volume by an oleophobic filter, open cell foam, steel mesh, PTFE filter membrane or the like, to prevent splashes of damping fluid from coming into direct contact with the adsorbent material, so blocking the pores. The benefit of this aspect can be felt in two ways.

Either the “cavity wall” of the twin tube damper can be made shallower without loss of performance in terms of the ramp-up in forces, accepting that the non-gaseous fluid overflow will reach a point higher up the cavity than in a conventional device. This will serve to enlarge the cross-sectional area of the working chamber and hence achieve a greater piston surface area within the working chamber, leading to less wear and finer performance precision in the damping elements, and the use of more non-gaseous fluid within the working chamber, dissipating heat more effectively.

Or the “cavity wall” of the twin tube can be height-limited, no longer extending the full length of the working chamber. This gives rise to an opportunity to expose the wall of an upper portion of the working chamber directly to the surrounding air, significantly enhancing the ability of the device to transfer excess heat into the air. The portion of the walls containing activated carbon and/or open cell foam and possibly a heat conductive additive, such as graphite, will aid heat conduction to the outer wall. However, the process can be enhanced using “heat sink” fins emanating from the exposed portion of the working chamber. Such fins can be formed alongside the working chamber cylinder as part of a single extrusion, with the fins acting as structural reinforcement, thereby enabling a thinner gauge of aluminium to be used which in turn enables more efficient heat dissipation from the working volume.

According to another aspect of the invention, a quantity of adsorptive material and/or open cell foam is disposed in the pressurised gas chamber of the auxiliary or “piggyback” chamber of a damper. This is beneficial in either of two ways; the same physical dimensions of auxiliary chamber and pressurised chamber can be used, but with improved performance in terms of a reduction in force build-up toward the end of travel. Or a smaller pressurised chamber volume can be used, similar to the configurations in the aspects of the invention, so reducing the size, weight and cost of the component without any performance penalty.

In all scenarios, the activated carbon granules need to be contained in such a way as to stop powder from being generated due to abrasion caused by particles grinding against one another when the mass is vibrated. This can be achieved by binding the granules together to form a self-supporting monolith, using a small quantity of binder in either aqueous or dry powder epoxy form. Another method is to contain the carbon mass in its own compartment, using a grid-like gauze to bear down on the granular mass through a compressible layer of flexible open-cell foam, which also acts as a filter to keep fine granules from entering the pressurised cavity where they might interfere with performance of the dynamic seals and cause unwanted wear. The foam may itself be oiled, to enhance filtering effect, and may be impregnated with an oleophobic coating to help guard against contamination of the activated carbon from exposure to the damping fluid.

A band of this material may be used in the twin-tube embodiment to separate the adsorptive mass from the overflow of damping fluid in the cavity wall.

The choice of activated carbon types is also be critical. Highly microporous carbons tend to be highly temperature-sensitive, meaning that they desorb stored gas as temperature rises, causing the pressure in any cavity they are housed in to rise steeply. The working volume of oil or damping fluid inside a damper experiences significant temperature gains during heavy operation, as kinetic energy is dissipated as heat inside the damping orifices. This effect is mitigated using highly mesoporous activated carbons such as those manufactured from wood. These cause a lower rise in pressure upon heating, like that seen in air. They have the added benefit of not being spoiled by exposure to volatile organic compounds such as oil fumes, because of their larger pore size.

### EXPERIMENTAL RESULTS

### Experiment 1

A cylindrical chamber of length 240 mm and diameter 32 mm was pressurised to 3 bar and compressed by 100 mm in 15 steps, with pressure measured in each step using a pressure transducer. The measured pressure (referenced to the starting pressure Po) is shown in FIG. 7, of both the empty chamber and of the same chamber with a 100 mm tall container filled with granular activated carbon (GAC). The activated carbon used was GCN3070 produced by Cabot. These are “static rate” curves. The benefit of introducing activated carbon is even greater in dynamic conditions, when the spring rate in the empty chamber increases by 40%, but the increase in the carbon chamber is much lower.

The relative benefit of introducing activated carbon is not sensitive to scale; if the carbon layer was 10 mm deep and cylinder 24 mm tall, the same curves would be generated by a 10 mm compression.

Reading horizontally on the graph, the same pressure increase can be achieved with a longer excursion into the cavity. For example, at full 100 mm excursion, the carbon-occupied cylinder reaches a pressure around 1.5 times that at the start of the stroke. The empty cylinder reaches this pressure point at around 75 mm excursion meaning that, using activated carbon, this chamber could be made 25 mm shorter to top-out at the same pressure as the empty cylinder.

A more fully optimised configuration could generate a greater proportional height saving, but the benefit varies according to carbon type, pressure and temperature.

### Experiment 2

An aluminium cylinder was filled with two types of granular activated carbon and heated slowly in a water bath. Pressure readings were taken at regular intervals. The measured pressure (referenced to the starting pressure Po) is shown in FIG. 8. The solid black line shows the rise in pressure in a cylinder filled with only air at 2.5 bar. The dotted line shows the rise of pressure when the cylinder was filled with Cabot GCN3070 microporous carbon. The dashed line shows the rise in pressure with a wood-based mesoporous carbon, sourced from Ingevity, similar to the Nuchar WV-A 1500.

### BRIEF DESCRIPTION OF THE DRAWINGS

FIG. 1 Illustrates a gas-charged monotube damper in compressed and extended states.

FIG. 2 illustrates a gas charged monotube damper with the floating piston replaced by a flexible membrane

FIG. 3 illustrates a monotube gas-charged damper with an auxiliary or piggyback chamber.

FIG. 4 illustrates a standard twin tube gas-charged damper in compressed and extended states.

FIG. 5 illustrates a proposal for a novel twin tube gas-charged damper which preserves some of the benefits of a monotube configuration.

FIG. 6 illustrates an alternative gas-charged monotube configuration with the adsorptive mass housed within a floating piston.

FIG. 7 illustrates the change in pressure in a cavity under compression partially occupied by activated carbon, compared to an empty cavity.

FIG. 8 illustrates the effect of temperature on pressure in a sealed pressurised cavity using two types of activated carbon.

FIG. 9 compares the hysteresis in damping forces in a gas charged damper, with-and-without an adsorptive material disposed within the pressurised gas cavity

### DESCRIPTION OF THE DRAWINGS IN DETAIL

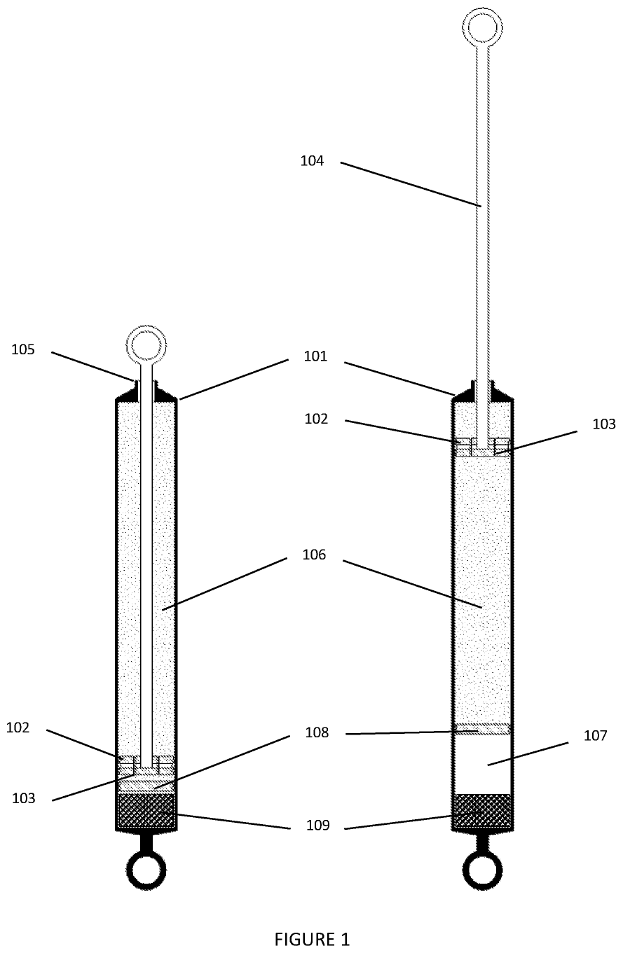

FIG. 1 Illustrates an example of a hydropneumatic suspension component being a gas-charged monotube damper in compressed and extended states. The device is formed of a cylinder (101) that comprises a variable-volume chamber having a first portion volume (107) for holding a pressurised gas and a separate second portion volume (106) for holding a non-gaseous fluid used as a damping medium. An example of a non-gaseous fluid, preferably non-gaseous damping fluid, is an oil such as hydraulic oil.

The cylinder (101) comprises a piston (102) containing damping orifices (103) that is actuated via a piston rod (104) which enters one end of the cylinder (101) comprising the second proportion volume (106) through a sealed opening (105). The second portion volume (106) is entirely filled with non-gaseous fluid (such as oil), and in use the pressurised gas in the first portion volume (107) exerts pressure on the non-gaseous damping fluid via a floating piston (108).

A mass of adsorptive material (109) is disposed within the first portion volume (107) (i.e. the pressurised gas chamber). This limits the build-up of pressure in the damper as the first portion volume (107) is compressed in use by the non-gaseous fluid provided in the second portion volume (106). Additionally, and/or alternatively to the adsorptive material (109), a mass of open-cell foam can be disposed within first portion volume (107).

As shown, the non-gaseous fluid in the second portion volume (106) is isolated from the adsorbent material (109) (and/or open-cell foam) in the first portion volume (107) by the floating piston (108). This means the non-gaseous fluid in the second portion volume (108) is prevented from mixing and/or contacting the first portion volume (107).

In one embodiment, the first portion volume (107) is fluidly sealed from the second portion volume (106) by the floating piston (108). This means that the adsorbent material (109) (and/or open-cell foam) and the pressured gas in the first portion volume (107) are prevented from mixing and/or contacting the non-gaseous fluid in the second portion volume (106).

It will be appreciated that such isolation and/or sealing may also be achieved by a flexible divider, such as a flexible impervious membrane or any other dividing means to enable the exertion of pressure on the non-gaseous fluid in the second portion volume by the pressurised gas in the first portion volume.

For the avoidance of doubt, the volume of the first portion volume (107) increases in direct proportion to the amount of piston rod (104) that exits the second portion volume (106) upon extension of the device. The volume of the first portion volume (107) decreases in direct proportion to the amount of piston rod (104) that enters the second portion volume (106) upon compression of the device.

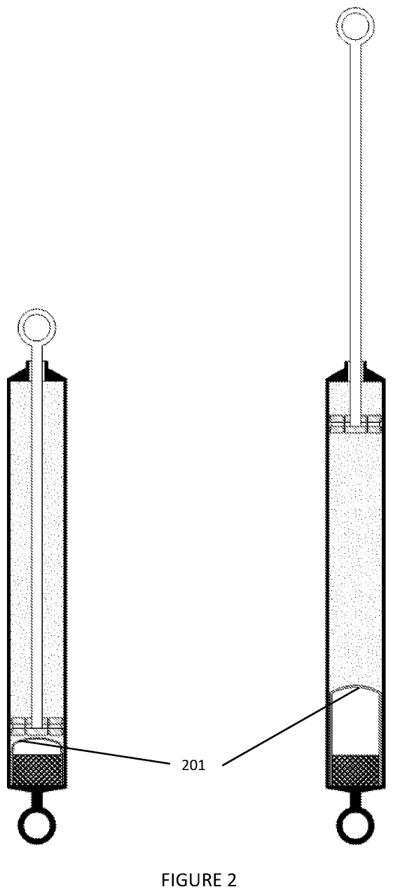

FIG. 2 illustrates a gas charged monotube damper with a similar working configuration to FIG. 1, but with the floating piston (102) replaced with a flexible membrane (201). This provides an alternative means of isolating the adsorbent material (and/or open-cell foam) in the first portion volume from the non-gaseous fluid in the second portion volume. Again, the effect is that the non-gaseous fluid in the second portion volume is prevented from mixing and/or contacting the first portion volume. The flexible member could further act to fluidly seal the first portion volume from the second portion volume. This would mean that the adsorbent material (and/or open-cell foam), and the pressured gas in the first portion volume are prevented from mixing and/or contacting the non-gaseous fluid in the second portion volume.

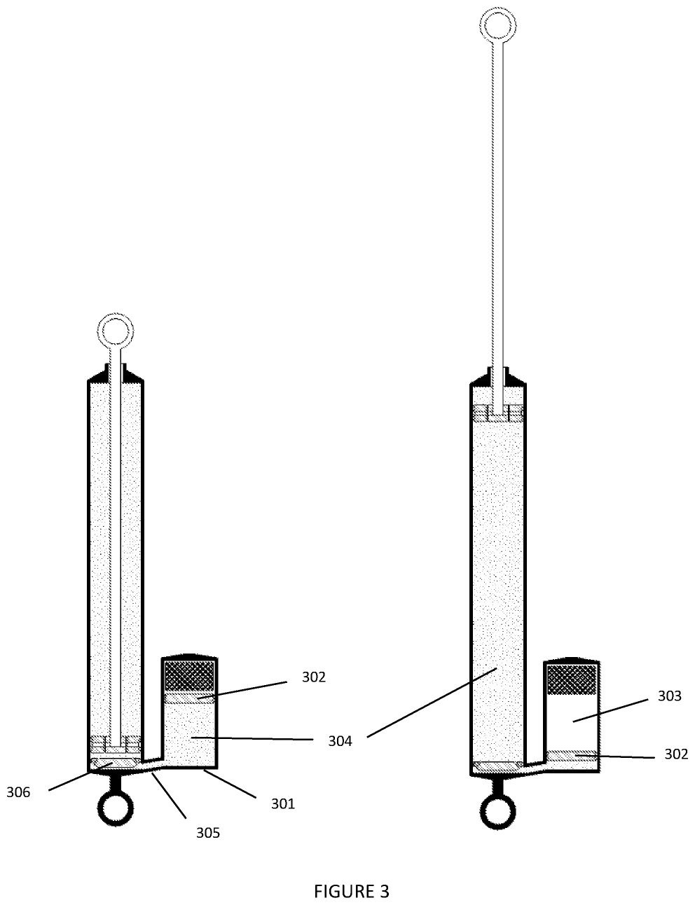

FIG. 3 illustrates a monotube gas-charged damper with an auxiliary or piggyback chamber in compressed and extended states. The chamber comprises a variable-volume chamber having a first portion volume (303) for holding a pressurised gas and a separate second portion volume (304) for holding a non-gaseous fluid used as a damping medium. The piggyback chamber further comprises a mass of adsorptive material disposed within the first portion volume (303). Additionally, and/or alternatively to the adsorptive material, a mass of open-cell foam can be disposed within first portion volume (303).

As shown, the second portion volume (304) extends to a main chamber of the damping device and is provided to be in fluid communication with a non-gaseous fluid provided in a main chamber of the damping device. This fluid connection from the piggyback chamber to the main chamber may be via a rigid or non-rigid connection. Such a connection may comprise a valve (306) between the main chamber and the piggyback chamber to control the flow of non-gaseous fluid, and therefore may afford fine damping control. Additionally, or alternatively, such a valve (306) may be provided to the main chamber itself (as shown) and/or to the piggyback chamber.

As shown, a floating piston (302) now sits within the auxiliary chamber (301). This means that the second portion volume (304) is isolated from the adsorbent material (and/or open cell foam) in the first portion volume (303). As such, the non-gaseous fluid in the second portion volume (304) is prevented from mixing and/or contacting the first portion volume (303).

In one embodiment, the first portion volume (303) is fluidly sealed from the second portion volume (304) by the floating piston (302). This means that the adsorbent material (and/or open cell foam) and the pressured gas in the first portion volume (303) are prevented from mixing and/or contacting the non-gaseous fluid in the second portion volume (304).

Providing the piggyback chamber with a mass of adsorptive material disposed within the first portion volume (303) limits the build-up of pressure in the damper device as the first portion volume (303) is compressed in use by the non-gaseous fluid provided in the second portion volume (304).

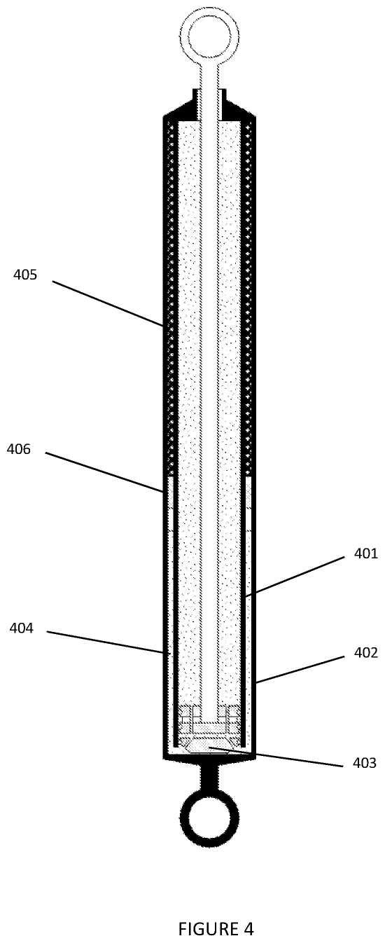

FIG. 4 illustrates a standard twin tube gas-charged damper in a compressed state. The device comprises an inner tube (401) that is housed within an outer tube (402). A piston and piston rod are provided to the inner tube (401) as shown.

The damper comprises a variable-volume chamber that comprises a first portion volume for holding a pressurised gas and a separate second portion volume, for holding a non-gaseous fluid used as a damping medium. The second portion volume is provided within the inner tube (401) and extends from a sealed end of the inner tube (401) to an open end of the inner tube (401). The second portion volume further extends from an open end of the inner tube (401) to a void or cavity provided between the inner tube (401) and the outer tube (402). As shown the second portion volume in the cavity (404) may extend to around a mid-point of the cavity or may extend to around 25 to 75% of the length of the cavity.

The device further comprises a valve (403) to manage the flow of non-gaseous fluid in the second portion volume. In particular, as shown, it may be position at the open end of the inner tube (401) to control the flow of non-gaseous fluid from within the inner tube, to the cavity.

A first portion volume for holding a pressurised gas is provided within the remaining section of the cavity that is not occupied by the second portion volume.

In one embodiment as shown, the first portion volume contains a mass of adsorptive material (405) to limit the build-up of pressure as the first portion volume is compressed in use by the non-gaseous fluid provided in the second portion volume. The non-gaseous fluid in the second portion volume is also kept under pressure by the pressured gas provided in the first portion volume.

The adsorbent material (405) in the first portion-volume (which takes either monolith or granular form) and the pressurised gas, is isolated from non-gaseous fluid by a band of oleophobic foam or filter material (406) which circumvents the cavity and provides a means to separate the first portion volume from the second portion volume. The effect is that the non-gaseous fluid in the second portion volume is prevented from mixing and/or contacting the first portion volume.

In one embodiment, the first portion volume may additionally or alternatively to the adsorbent material (405), comprise a mass of open-cell foam. The mass of open-cell foam may substantially fill the first portion volume of the device. Due to the mass of open-cell foam in the first portion volume, this means the non-gaseous fluid in the second portion volume is prevented from mixing and/or contacting the first portion volume.

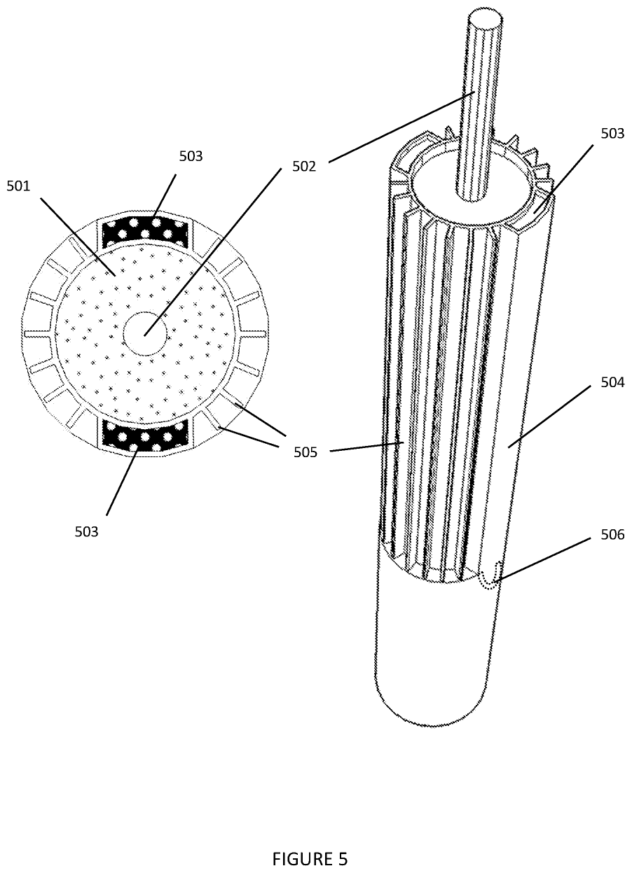

FIG. 5 illustrates a proposal for a novel twin tube gas-charged damper which preserves some of the benefits of a monotube configuration.

The damper comprises a variable-volume chamber that comprises a first portion volume (503) for holding a pressurised gas and a separate second portion volume (501), for holding a non-gaseous fluid used as a damping medium. The non-gaseous fluid surrounds a piston rod (502) and piston similar to the embodiment shown in FIG. 4.

As shown from FIG. 5, the first-portion volume (503) is provided in one or more conduits (504) that partially surround an outer surface of a housing comprising the second portion volume (501). It is preferable that the housing is tubular, or as a tube with a circular cross section, as shown. The first-portion volume (503) may be provided in two or more conduits (504) as shown. The one or more conduits surround from 10 to 90%, preferably from 10 to 75%, further preferably from 20 to 60% of a circumference of the tubular housing. The housing may comprise one or more cooling fins and/or structural buttresses (505) on its outer surface that is not surrounded by the one or more conduits (as shown), to aid cooling of the second portion volume (501).

The first-portion volume (503) comprises a mass of adsorptive material to limit the build-up of pressure as the first portion volume (502) is compressed in use by the non-gaseous fluid provided in the second portion volume in a manner similar to the embodiment of FIG. 4. The first portion volume (503) may additionally or alternatively to the adsorptive material (405), comprises a mass of open-cell foam.

Ideally, the conduit (504) is limited to consist of the first portion volume (503), but it may comprise both the first-portion volume (503) and a portion of the second-portion volume (501) as per the embodiment of FIG. 4. In a preferred arrangement, and as shown, the pressurised gas and adsorbent material in the first portion-volume (503) is isolated from the non-gaseous fluid in the second portion volume (502) by oleophobic filters or open cell foam at the base (506) of the conduit (504). It could be envisaged that such filters or open cell foams could alternatively be provided to any section of the conduit (504) to isolate the second portion volume (501) from the first portion volume (501). The effect is that the non-gaseous fluid in the second portion volume is prevented from mixing and/or contacting the first portion volume.

As discussed above, the first portion volume may additionally or alternatively to the adsorbent material, comprise a mass of open-cell foam. The mass of open-cell foam may substantially fill the first portion volume of the device. Due to the mass of open-cell foam in the first portion volume, this means the non-gaseous fluid in the second portion volume is prevented from mixing and/or contacting the first portion volume.

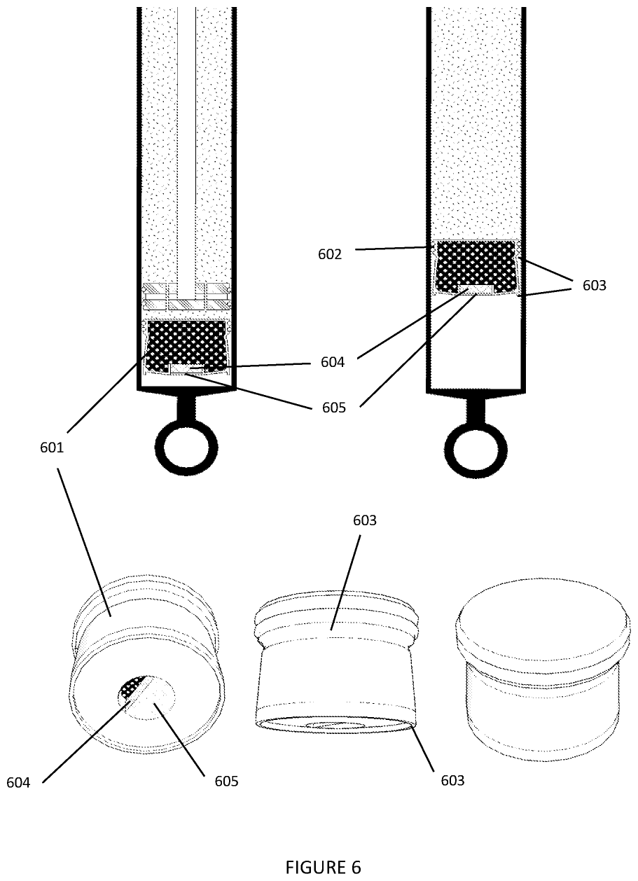

FIG. 6 illustrates an alternative gas-charged monotube configuration with a mass of adsorptive material housed contained within a hollowed out, extended floating piston (601).

As shown, the floating piston (601) comprises a main body (602) comprising a chamber having an opening (604), and in which the chamber contains a mass of adsorptive material and/or open-cell foam to limit the build-up of pressure in a hydropneumatic suspension component. The main body (602) is constructed from a plastics material and/or a metal material.

Protection to the adsorptive material is enhanced by the use of an oleophobic filter, foam or membrane behind a grill or broad mesh (605) on the opening (604), to keep fine particles of dust from entering the hydropneumatic suspension component, where it may mix with the film of oil lubricating the walls and increase friction with the isolating seals.

The main body may be further provided with sealing and/or scrapping means (603) that are arranged to communicate with a bore of the hydropneumatic suspension component in use. Such means (603) or anti-drip details will help protect the adsorptive material from splashes of non-gaseous fluid (i.e. oil or damping fluid) in use. A projection such as a lip or a groove with an o-ring/piston ring would also achieve the same effect.

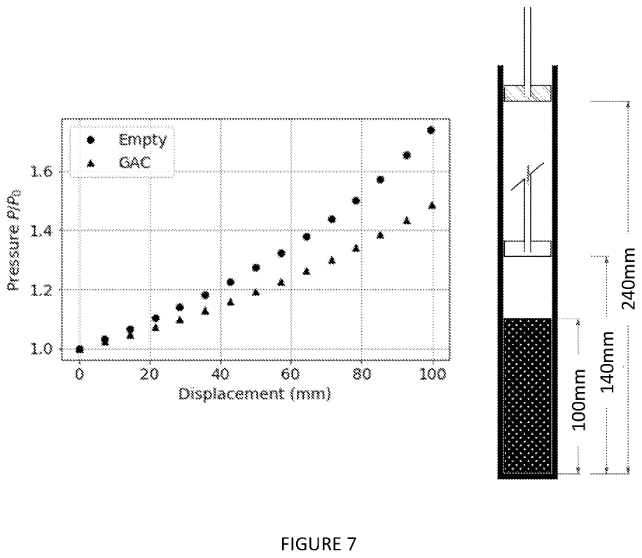

FIG. 7 illustrates the relative change in pressure as a chamber is compressed, with and without activated carbon being present. The experiment is described in detail in the Description.

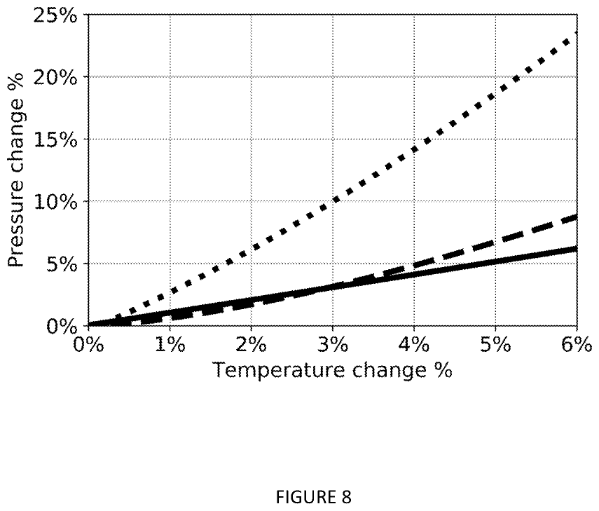

FIG. 8 illustrates the effect of temperature on relative pressure on a pressurised air-filled cavity containing a highly microporous activated carbon compared to one with fewer micropores and more mesopores. The experiment is described in more detail in the Description.

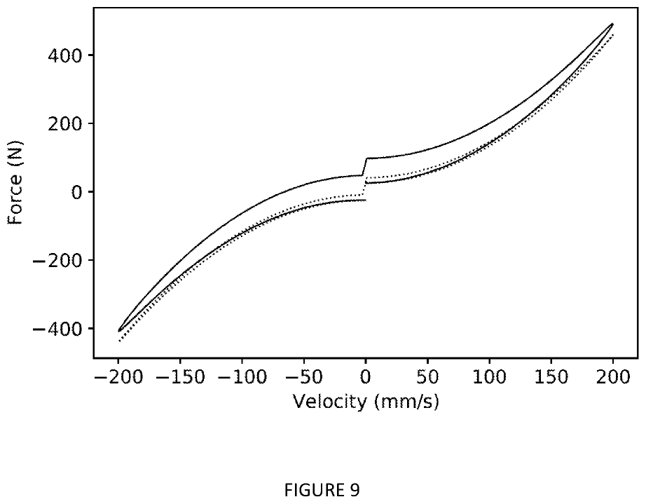

FIG. 9 illustrates damping force hysteresis in a gas charged damper. The solid line shows the damping force of a regular gas charged damper in compression and extension. The dotted line shows the damping force in the same device when activated carbon occupies the whole of the gas charged cavity at peak compression and at maximum operating temperature. The experiment shows substantially reduced hysteresis in the damper with adsorptive material disposed within the gas charged cavity.

1. A hydropneumatic suspension component comprising: a variable-volume chamber having a first portion volume for holding a pressurised gas and a separate second portion volume for holding a non-gaseous fluid used as a damping medium, wherein the first portion volume is isolated from the non-gaseous fluid in the second portion volume, and further wherein the first portion volume comprises a mass of an adsorptive material and/or an open-cell foam to limit the build-up of pressure as the first portion volume is compressed in use by the non-gaseous fluid provided in the second portion volume.

2. The hydropneumatic suspension component according to claim 1, wherein the adsorptive material is activated carbon.

3. The hydropneumatic suspension component according to claim 1, wherein the adsorptive material is in a loose granular form, and is provided in combination with an open cell foam and/or a fine gauze.

4. The hydropneumatic suspension component according to claim 1, wherein the open cell foam is treated with an oleophobic coating, or comprises intrinsic oleophobic qualities.

5. The suspension component according to claim 1, wherein the adsorptive material is in the form of a self-supporting element or monolith comprising granules bound together using a binder.

6. The hydropneumatic suspension component according to claim 1, in which the first portion volume is isolated from the non-gaseous fluid in the second portion volume by an element selected from a moveable member comprising a floating piston or a flexible divider; and any other dividing elements configured to enable exertion of pressure on the non-gaseous fluid in the second portion volume by the pressurised gas in the first portion volume.

7. The hydropneumatic suspension component according to claim 1, in which the first portion volume is provided in a cavity between an inner tube and an outer tube, and the first portion volume is isolated from the non-gaseous fluid in the second portion volume by an oleophobic filter or an open-cell foam.

8. The hydropneumatic suspension component according to claim 1, in which the first portion volume is provided in one or more conduits positioned on an outer surface of a tubular housing.

9. The hydropneumatic suspension component according to claim 8, wherein the outer surface comprises cooling fins on or adjacent the one or more conduits.

10. The hydropneumatic suspension component according to claim 8, wherein the conduit comprising the mass of an adsorptive material and/or open cell foam extends only partially along a length of the tubular housing, revealing the tubular housing to the outside air along the remainder of its length.

11. The hydropneumatic suspension component according to claim 8, in which the one or more conduits surround from 10 to 90% of a circumference of the tubular housing.

12. The hydropneumatic suspension component according to claim 11, in which the tubular housing is provided with one or more cooling fins on the circumference that is not surrounded by the one or more conduits.

13. The hydropneumatic suspension component according to claim 1, further comprising an auxiliary or “piggyback” chamber provided in fluid communication with the non-gaseous fluid in the second portion volume via a rigid or non-rigid connection, and housing the first portion volume.

14. The hydropneumatic suspension component according to claim 1, wherein the adsorptive material and/or open cell foam is attached to or contained within a moveable member, and the adsorptive material is in fluid communication with the first portion volume via a porous membrane or open-cell foam.

15. The hydropneumatic suspension component according to claim 1, wherein the adsorptive material is a bound unitary element of adsorptive material exposed to the first portion volume.

16. The hydropneumatic suspension component according to claim 1, wherein the adsorptive material and/or open cell foam are/is exposed to the first portion volume through one or more orifices.

17. The hydropneumatic suspension component according to claim 1, wherein the adsorptive material is an activated carbon featuring high levels of mesoporosity and low levels of microporosity.

18. The hydropneumatic suspension component according to claim 1, which is a gas charged damper.

19. A vehicle comprising a hydropneumatic suspension component according to claim 18.

20. (canceled)

21. (canceled)

22. (canceled)

23. A hydropneumatic suspension component comprising: a variable-volume chamber having a first portion volume for holding a pressurised gas and a separate second portion volume for holding a non-gaseous fluid used as a damping medium, wherein the first portion volume is provided in one or more conduits that partially surround an outer surface of a housing comprising the second portion volume.

24. The hydropneumatic suspension component according to claim 23, in which the housing comprising the second portion volume is tubular.

25. The hydropneumatic suspension component according to claim 24, in which the one or more conduits surround from 10 to 90% of a circumference of the tubular housing.

26. The hydropneumatic suspension component according to claim 25, in which the tubular housing is provided with one or more cooling fins on the circumference that is not surrounded by the one or more conduits.

27. The hydropneumatic suspension component according to claim 23, in which the first portion volume further comprises an adsorbent material and/or an open cell foam.

28. The hydropneumatic suspension component according to claim 27, in which the non-gaseous fluid in the second portion volume is isolated from the first portion volume by an oleophobic filter or an open-cell foam.

29. A floating piston for a hydropneumatic suspension component comprising: a main body comprising a chamber having an opening, and in which the chamber contains a mass of adsorptive material and/or open cell foam to limit the build-up of pressure in a hydropneumatic suspension component.

30. The floating piston according to claim 29, in which the main body is formed from a plastics material and/or a metal material.

31. The floating piston according to claim 29, in which the opening comprises a grill or a mesh, and in which the adsorptive material is provided in combination with an oleophobic filter, foam, or membrane.

32. The floating piston according to claim 29, in which the main body is further provided with sealing and/or scrapping elements that are arranged to communicate with a bore of the hydropneumatic suspension component in use.

33. The floating piston according to claim 32, further comprising a pressurised gas.

34. A hydropneumatic suspension component comprising a floating piston according to claim 29.

35. (canceled)

36. (canceled)
